(19) United States
(12) Patent Application Publication
(10) Pub. No.: US 2007/0291477 A1
(43) Pub. Date: Dec. 20, 2007

(54) Portable and mountable light bulb and fixture

(76) Inventor: Ajit Khubani, Saddle River, NJ (US)

Correspondence Address: COOPER & DUNHAM, LLP, 1185 AVENUE OF THE AMERICAS, NEW YORK, NY, 10036, US

(21) Appl. No.: 11/818,848

(22) Filed: Jun. 15, 2007

Related U.S. Application Data
(60) Provisional application No. 60/814,304, filed on Jun. 16, 2006.

(51) Int. Cl. F21L 4/00

(52) U.S. Cl. 362/191

(57) ABSTRACT

A light assembly includes a portable lamp unit that functions alone as a light source or may be combined with a base unit for permanent or temporary attachment to a surface. The lamp unit has a light transmitting means, a power source, and an operating means that together provide a portable light source. When associated with the base unit, the lamp unit becomes removably retained in the base unit, providing for use of the lamp unit at a fixed location, while remaining easily removable for portable use.

### CROSS REFERENCE TO RELATED APPLICATIONS

This application claims the benefit of U.S. Provisional Application No. 60/814,304 filed Jun. 16, 2006.

### BACKGROUND OF THE INVENTION

Removable electric light assemblies for use on vehicles such as motorcycles, in ovens, and as lanterns have been described in the prior art, see, for example, U.S. Pat. Nos. 5,820,254, 6,461,010, and 7,014,459. Unlike conventional flashlights, these devices allow for mounting or placement of the light assembly in a location for use, and removal for storage, replacement, or installation.

As light sources in a closed or open environment, these known prior art devices present certain disadvantages. For example, the light assembly for the motorcycle cannot function as a discrete light source apart from the vehicle. Similarly, the oven light assembly cannot be removed for use as a light source away from the oven. In addition, while electric lanterns are portable and functional discrete devices, typical lanterns, like flashlights, are not designed to be mounted to a surface.

The present invention addresses the disadvantages of conventional removable electric lights by providing a discrete electric light that can be mounted for long-term use as a permanent or temporary fixture in an environment, and yet be easily removed without the use of tools for use as a portable light source.

### SUMMARY OF THE INVENTION

The present invention provides a light assembly that is both portable and mountable. The light assembly can be attached to a surface as a fixed light source but is also easily removed to function as a portable light device. In particular, the light assembly of the invention combines a retaining element that is affixed to a surface but also releasably retains the light emitting element. The light emitting element unites with or detaches from the retaining element without the use of any tools and functions as a discrete portable light source when removed from the retaining element. The retaining element may be permanently or temporarily attached to a surface to easily add a light source where necessary or desired. The associated light emitting element remains removable and portable.

One object of this invention is to provide a light assembly that includes (1) a portable lamp unit having a light transmitting means, a power source, and an operating means for activating the power source, where the light transmitting means has at least one light source, such as an incandescent light, a halogen light, a fluorescent light, a high intensity discharge lamp, and/or a light emitting diode and/or a laser; and (2) a base unit having a retaining means to releasably hold the lamp unit and a fastening means to attach the base unit to a surface.

In the portable lamp unit of the light assembly, the power source can be one or more batteries or an external power source. The operating means of the lamp unit can further include an actuator connected to the power source and can be a string, a button, a slide switch, and/or a sensor. The lamp unit can also include a light permeable shell that encloses at least a portion of the lamp unit, where the shell has a screw-type, snap-type, or other type of connector for connecting to the lamp unit.

Another object of the invention is to provide a retaining means for the base unit of the light assembly that allows for the lamp unit to be slid into and out of the retaining means without locking such that the lamp unit is readily and easily removable. The retaining means can be a sleeve, a hook and loop fastener, a clip, a socket, a cavity, and/or a groove. The fastening means of the base unit of the light assembly can be an adhesive, a screw, a nail, a bolt, and/or a dowel. The base unit of the light assembly may be attached to a surface, such as, for example, a wall, ceiling, shelf, or door, either temporarily or permanently.

A further object of the invention is to provide a light assembly having a portable lamp unit having a light transmitting means, a power source, and an operating means for activating the power source, wherein the light transmitting means has at least one light source; and a base unit having a retaining means to releasably hold the lamp unit and a fastening means to attach the base unit to a surface. The operating means can activate the power source and the light transmitting means can have at least one light source. The retaining means can allow for the lamp unit to be slid in and out without locking and can have a sleeve, a hook and loop fastener, a clip, a socket, a cavity, and/or a groove. Also, the fastening means can be an adhesive, a screw, a nail, a bolt, and/or a dowel. In addition, the base unit can be permanently or temporarily attached to the surface which can be a wall, ceiling, shelf, and/or door.

Another object of the invention is to provide a light permeable shell for enclosing at least a portion of the lamp unit. The shell can have a connector for connecting to the lamp unit and the connector can be a screw-type connector and/or a snap-type connector.

An additional object of the invention is to provide the power source as at least one battery, the power source being activated by an actuator which can be a string, a button, a slide switch, and /or a sensor. Also, the light source can be an incandescent light, a halogen light, a fluorescent light, a high intensity discharge lamp, a light emitting diode, and/or a laser.

Another object of the present invention is to provide a method of using the light assemblies described above having the steps of: (a) mounting the base unit onto a surface; (b) sliding the lamp unit into the base unit; and (c) using the operating means to activate the power source. The method can also include the steps of (a) sliding the lamp unit out of the base unit; and (b) transporting the lamp unit.

### BRIEF DESCRIPTION OF THE DRAWINGS

FIG. 1 shows a front perspective view of the lamp unit of one embodiment of the invention;

FIG. 2 shows a perspective view of the interior of the lamp unit of one embodiment of the invention;

FIG. 3 shows a top perspective view of the interior of the lamp unit of one embodiment of the invention;

FIG. 4 shows a bottom perspective view of a power source of one embodiment of the lamp unit of the invention;

FIG. 5 shows a front perspective view of the base unit of one embodiment of the invention;

FIG. 6 shows a rear perspective view of the base unit of one embodiment of the invention;

FIG. 7 shows a perspective view of a lamp unit releasably retained in the base unit of one embodiment of the invention;

FIG. 8 shows a side perspective view of the lamp unit of another embodiment of the invention with a light permeable shell; and

FIG. 9 shows a side perspective view of a light permeable shell of one embodiment of the invention with a screw-type connector.

### DETAILED DESCRIPTION OF THE INVENTION

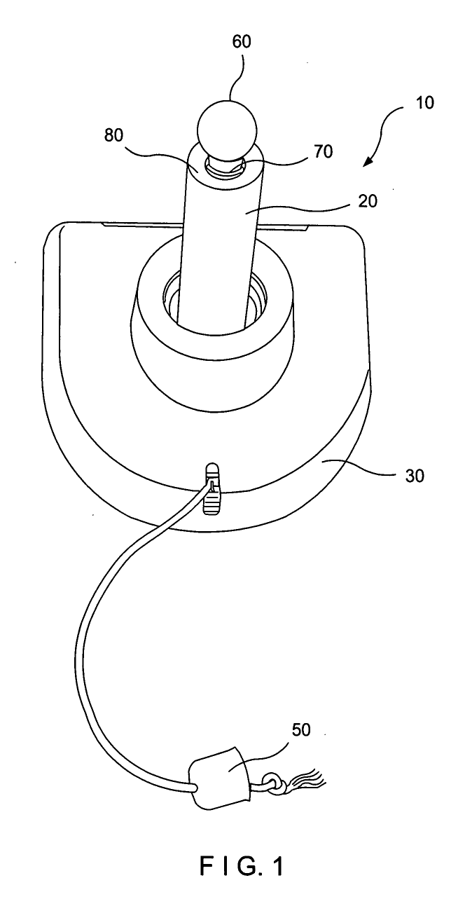

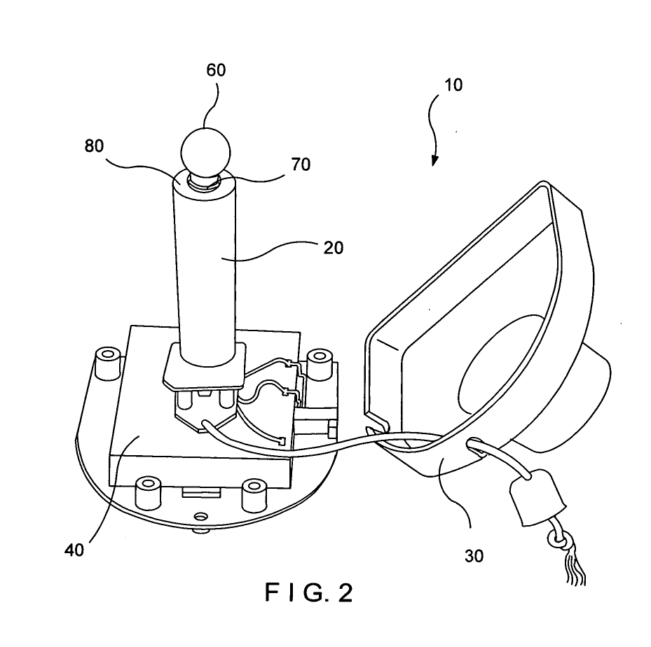

Referring to the drawings, FIG. 1 shows a discrete lamp unit 10 of one embodiment of the invention. The lamp unit 10 includes a light transmitting means 20, a casing 30 enclosing a power source 40 (FIG. 2), and an operating means 50 accessible from outside the casing 30. The lamp unit 10 is portable, that is, capable of functioning independently. The light source 60 of the light transmitting means 20 can be any light source capable of illuminating an area, for example, an incandescent light, a halogen light, a fluorescent light, a high intensity discharge lamp, a light emitting diode, a laser, or any combination of these or other light sources.

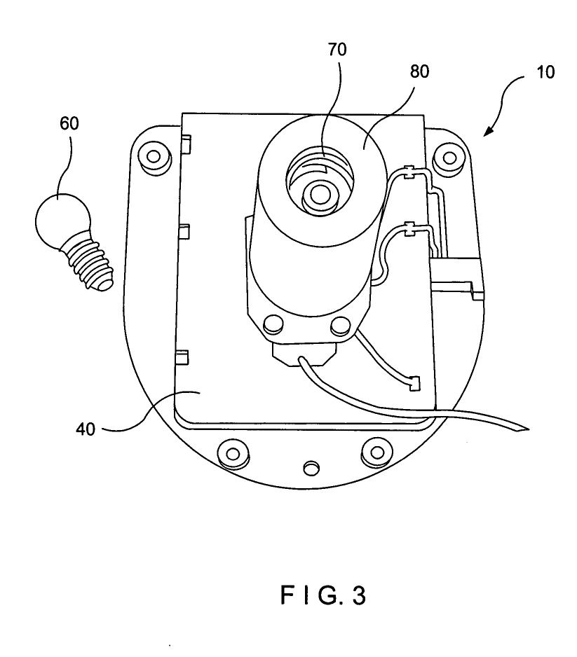

In one embodiment shown in FIG. 3, the light source 60 is a halogen bulb filled with krypton gas for longer life and less energy consumption. The light source 60 can be mounted directly to the casing 30, but in one embodiment is attached by a screw-type connector 70, which in turn is mounted on a platform 80, as shown in FIGS. 2 and 3. The electrical connection of the screw-type connector 70 to the power source 40 through a switch (not shown) is conventional.

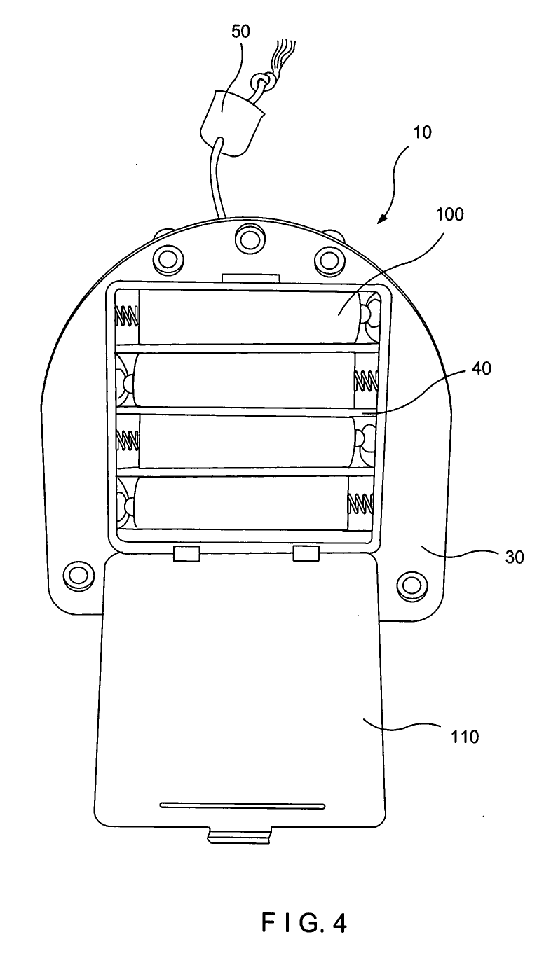

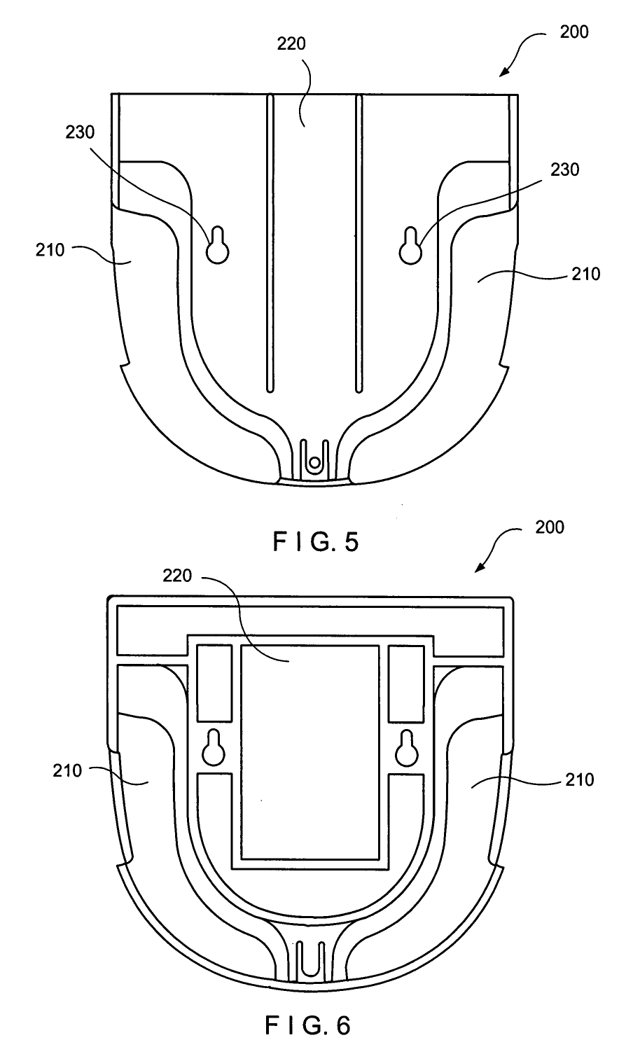

The power source 40 within the casing 30 has at least one direct power source, such as one or more batteries 100, as in FIG. 4 showing a bottom perspective view of an embodiment of the lamp unit, or an external power source attached through a receptacle in the casing 30. Such an external power source can be a transformer from an alternating current source such as a conventional electric outlet (not shown), or a combination of power sources. The external power source is particularly useful when the light unit is in the base unit 200 (FIG. 5) and the base unit is mounted near a conventional outlet. FIG. 4 shows a door 110 that provides access to the power source 40 such as one or more batteries inside the casing 30.

The operating means 50 of the lamp unit 10 has an actuator (not shown) that allows activation of the power source 40. In one embodiment, the operating means 50 is a string. However, any switch actuator can be used, for example, push button(s), slide switches, sensors, et cetera.

FIG. 5 shows the base unit 200 of one embodiment of the invention. The base unit 200 has a retaining means 210 that allows the lamp unit 10 to be slid in, without locking, so that the lamp unit 10 can be removably mounted by means of the base unit 200, or easily slid out as a separate, portable device. In one embodiment, the retaining means 210 is at least one sleeve adapted to receive the casing 30 of the lamp unit 10. In another embodiment, the base unit 200 has at least two retaining means 210 adapted to receive the lamp unit 10. Other retaining means, such as, for example, hook and loop fasteners, clips, sockets, cavities, grooves, et cetera can also be employed.

The base unit 200 shown in FIG. 5 also has a fastening means 220 for attaching the base unit 200 to a surface such as a wall, ceiling, shelf, or door. The fastening means 220 shown in FIG. 5 has apertures 230 that can accommodate one or more screws, nails, bolts, dowels, or other means to attach the base unit 200 to a surface.

FIG. 6 shows a rear perspective view of one embodiment of the base unit 200. The drawing shows the back of the retaining means 210 and the fastening means 220. In one embodiment, the fastening means 220 can accommodate an adhesive such as a two-sided adhesive pad (not shown) for temporarily or permanently attaching the base unit 200 to a surface instead of or in addition to the fastening means 220.

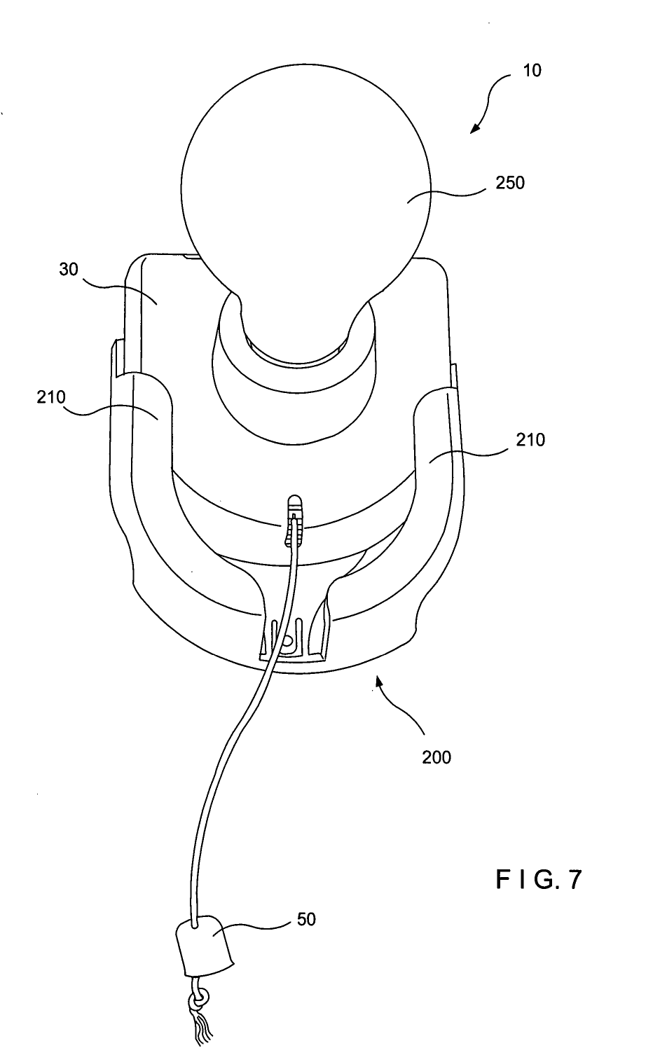

FIG. 7 shows the present invention as an assembly of the lamp unit 10 and the base unit 200. The drawing illustrates the lamp unit 10 sliding into place, guided by the retaining means 210 of the base unit 200, such that the retaining means 210 releasably holds the lamp unit 10 by the casing 30. FIG. 7 also shows the operating means 50 of the lamp unit 10 as a string. The string connects to a conventional switch (not shown) for the power source 40, such that pulling the string 50 reversibly activates the power source 40 to provide or to stop providing power to the light transmitting means 20.

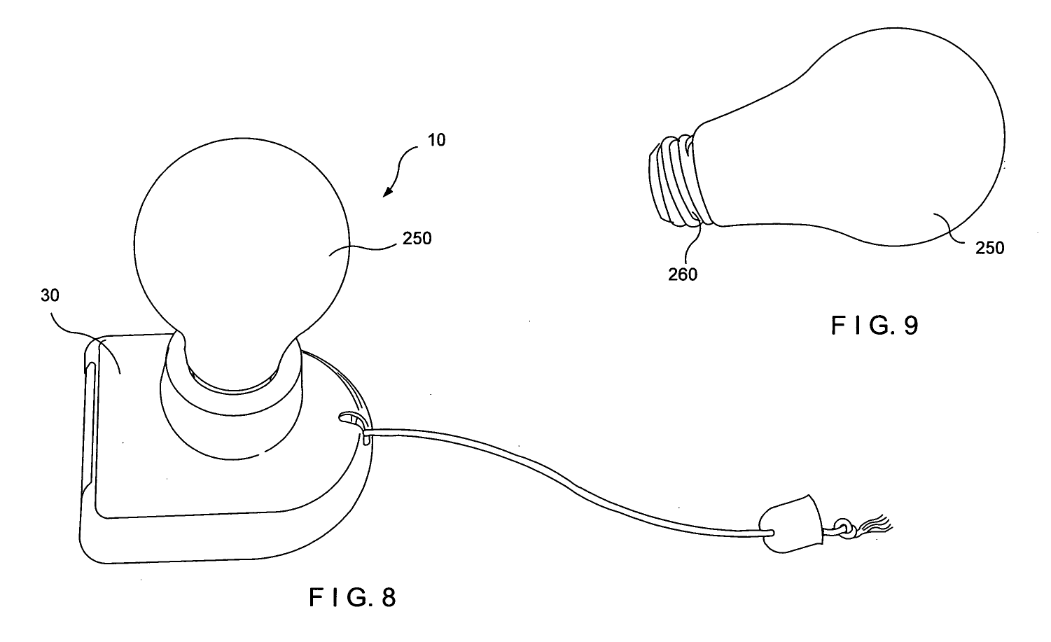

FIGS. 7 and 8 show a light permeable shell 250 that encloses at least a portion of the lamp unit 10. In an embodiment, the shell 250 is formed from a clear or translucent plastic to appear as a conventional light bulb envelope. The shell 250 is attached to the casing 30 by a connector 260 (FIG. 9), which may be a screw-type, a snap-type, or another type of connector. In one embodiment, the connector 260 is complementary to a connector (not shown) formed in the casing 30 to provide for a reversible attachment. To replace the light source 60 of the light transmitting means, one need only unscrew the shell 250, replace the light source 60 and reattach the shell 250. FIG. 9 further shows a side perspective view of a light permeable shell 250 separated from the lamp unit 10 and base unit 200.

While the present invention has been described with respect to preferred embodiments, those skilled in the art will appreciate that various adaptations and modifications of the embodiments may be made without departing from the scope and spirit of the invention. Therefore, it is to be understood that the invention may be practiced other than as specifically described above, within the scope of the appended claims.

What is claimed is:

1. A light assembly comprising:
a portable lamp unit having a light transmitting means, a power source, and an operating means for activating the power source, wherein the light transmitting means has at least one light source; and
a base unit having a retaining means to releasably hold the lamp unit and a fastening means to attach the base unit to a surface.

2. The light assembly of claim 1, wherein the retaining means allows for the lamp unit to be slid into and out of the retaining means without locking.

3. The light assembly of claim 1, wherein the retaining means is selected from the group consisting of at least one of a sleeve, a hook and loop fastener, a clip, a socket, a cavity, and a groove.

4. The light assembly of claim 1, wherein the fastening means is selected from the group consisting of at least one of an adhesive, a screw, a nail, a bolt, and a dowel.

5. The light assembly of claim 1, wherein the base unit is attached to the surface.

6. The light assembly of claim 4, wherein the surface is selected from the group consisting of a wall, ceiling, shelf, and door.

7. The light assembly of claim 1, further comprising a light permeable shell for enclosing at least a portion of the lamp unit.

8. The light assembly of claim 7, wherein the light permeable shell has a connector for connecting to the lamp unit.

9. The light assembly of claim 8, wherein the connector is a screw-type connector.

10. The light assembly of claim 8, wherein the connector is a snap-type connector.

11. The light assembly of claim 1, wherein the power source is at least one battery.

12. The light assembly of claim 1, wherein the operating means further comprises an actuator connected to the power source and selected from the group consisting of at least one of a string, a button, a slide switch, and a sensor.

13. The light assembly of claim 1, wherein the base unit is temporarily attached to the surface.

14. The light assembly of claim 1, wherein the base unit is permanently attached to the surface.

15. The light assembly of claim 1, wherein the light source is selected from the group consisting of at least one of an incandescent light, a halogen light, a fluorescent light, a high intensity discharge lamp, a light emitting diode, and a laser.

16. A light assembly comprising:
a portable lamp unit having a light transmitting means, a power source, and an operating means; and
a base unit having a retaining means to releasably hold the lamp unit and a fastening means to attach the base unit to a surface.

17. A method of using the light assembly of claim 1 comprising the steps of:
mounting the base unit onto a surface;
sliding the lamp unit into the base unit; and
using the operating means to activate the power source.

18. The method as in claim 17 further comprising the steps of:
sliding the lamp unit out of the base unit; and
transporting the lamp unit.
